(19) United States
(12) Patent Application Publication
(10) Pub. No.: US 2026/0222657 A1
(43) Pub. Date: Jul. 30, 2026

(54) CHART PROCESSING METHOD AND APPARATUS

(71) Applicant: Beijing Zitiao Network Technology Co., Ltd., Haidian District, Beijing (CN)

(72) Inventor: Jianyou FANG, Beijing (CN)

(21) Appl. No.: 19/149,229

(22) PCT Filed: Dec. 12, 2023
(86) PCT No.: PCT/CN2023/138152

§ 371 Date: Jul. 18, 2025

(30) Foreign Application Priority Data
Jan. 20, 2023 (CN) 202310102344.2

(51) Int. Cl. H04N 21/81; G06T 11/26

(52) U.S. Cl. CPC H04N 21/8153; G06T 11/26

(57) ABSTRACT

The present application discloses a chart processing method. The method includes: acquiring chart materials, and acquiring chart display parameters and a chart preview parameter. After that, acquiring, based on the chart materials and the chart display parameters, a chart video frame, and acquiring, based on the chart materials, the chart display parameters, and the chart preview parameter, a chart preview frame. Then, acquiring, based on the chart preview frame and the chart video frame, a target chart video.

### CROSS-REFERENCE TO RELATED APPLICATION(S)

The present disclosure claims the priority from the CN patent application No. 202310102344.2 entitled “Chart processing method and apparatus” filed with the China National Intellectual Property Administration (CNIPA) on Jan. 20, 2023, the contents of which are hereby incorporated by reference in their entirety.

### FIELD

The present disclosure relates to the technical field of computers, in particular, to a chart processing method and apparatus.

### BACKGROUND

With the capability of intuitively displaying data information, the charts are becoming more and more popular among users. Nowadays, users can view online charts on a front-end page. In addition to viewing the online charts on the front-end page, the users have a further need for generating chart videos dynamically.

In the case, how to meet the aforesaid users' needs is an urgent technical problem to be solved.

### SUMMARY

In order to solve, or at least partly solve, the above technical problem, the embodiments of the present disclosure provide a chart processing method and apparatus.

In a first aspect, the embodiments of the present disclosure provide a chart processing method, comprising:
acquiring chart materials;
acquiring chart display parameters and a chart preview parameter;
acquiring, based on the chart materials and the chart display parameters, a chart video frame;
acquiring, based on the chart materials, the chart display parameters, and the chart preview parameter, a chart preview frame; and
acquiring, based on the chart preview frame and the chart video frame, a target chart video.

Alternatively,
the chart materials comprise: data, a title, a label, and a legend; and
the chart display parameters comprise: at least one or more of color, font, font size, and type.

Alternatively, acquiring the chart preview parameter comprises:
in response to a preview-time selection operation triggered in a chart video preview window, acquiring a selected first time; and
acquiring, based on the chart materials, the chart display parameters, and the chart preview parameter, the chart preview frame comprises:
acquiring, based on the chart materials and the chart display parameters, a chart preview frame corresponding to the first time.

Alternatively, acquiring, based on the chart materials and the chart display parameters, the chart video frame comprises:
processing, by a rendering module, the chart materials and the chart display parameters using a script model to acquire a first chart rendering object; and
rendering, by the rendering module and based on the first chart rendering object, the chart video frame.

Alternatively, the method further comprises:
sending, by the rendering module, the chart video frame to a video synthesis module;
acquiring, based on the chart preview frame and the chart video frame, the target chart video comprises:
acquiring, by the video synthesis module and based on the chart preview frame and the chart video frame, the target chart video.

Alternatively, acquiring, based on the chart materials, the chart display parameters, and the chart preview parameter, the chart preview frame comprises:
processing the chart materials, the chart display parameters, and the chart preview parameter using the script model to acquire a second chart rendering object; and
rendering, based on the second chart rendering object, the chart preview frame.

Alternatively, acquiring, based on the chart preview frame and the chart video frame, the target chart video comprises:
in response to a preset operation triggered on a preview interface of the chart preview frame, acquiring, based on the chart video frame, the target chart video.

In a second aspect, the embodiments of the present disclosure provide a chart processing apparatus, comprising:
a first acquiring unit for acquiring chart materials;
a second acquiring unit for acquiring chart display parameters and a chart preview parameter;
a first processing unit for acquiring, based on the chart materials and the chart display parameters, a chart video frame;
a second processing unit for acquiring, based on the chart materials, the chart display parameters, and the chart preview parameter, a chart preview frame; and
a third processing unit for acquiring, based on the chart preview frame and the chart video frame, a target chart video.

Alternatively,
the chart materials comprise: data, a title, a label, and a legend; and
the chart display parameters comprise: at least one or more of color, font, font size, and type.

Alternatively, acquiring the chart preview parameter comprises:
in response to a preview-time selection operation triggered in a chart video preview window, acquiring a selected first time; and
the second processing unit is used for:
acquiring, based on the chart materials and the chart display parameters, a chart preview frame corresponding to the first time.

Alternatively, the first processing unit is used for:
processing, by a rendering module, the chart materials and the chart display parameters using a script model to acquire a first chart rendering object; and
rendering, by the rendering module and based on the first chart rendering object, the chart video frame.

Alternatively, the apparatus further comprises:
a sending unit for sending, by the rendering module, the chart video frame to a video synthesis module;
a third processing unit for:
acquiring, by the video synthesis module and based on the chart preview frame and the chart video frame, the target chart video.

Alternatively, the second processing unit is used for:
processing the chart materials, the chart display parameters, and the chart preview parameter using the script model to acquire a second chart rendering object; and
rendering, based on the second chart rendering object, the chart preview frame.

Alternatively, the third processing unit is used for:
in response to a preset operation triggered on a preview interface of the chart preview frame, acquiring, based on the chart video frame, the target chart video.

In a third aspect, the embodiments of the present disclosure provide a device, comprising a processor and a memory;
wherein the processor is configured to execute instructions stored in the memory, to cause the device to perform the method according to any of items in the first aspect.

In a fourth aspect, the embodiments of the present disclosure provide a computer readable storage medium comprising instructions that instruct an apparatus to perform the method according to any of items in the first aspect.

In a fifth aspect, the embodiments of the present disclosure provide a computer program product that causes, when running on a computer, the computer to perform the method according to any of items in the first aspect.

Compared with the prior art, the embodiments of the present application have the following advantages:

The embodiments of the present disclosure provide a chart processing method. In an example, the method includes: acquiring chart materials; acquiring chart display parameters and a chart preview parameter; acquiring, based on the chart materials and the chart display parameters, a chart video frame; acquiring, based on the chart materials, the chart display parameters, and the chart preview parameter, a chart preview frame; and acquiring, based on the chart preview frame and the chart video frame, a target chart video. With the solution, a chart video frame can be acquired based on the chart materials and the chart display parameters while a chart preview frame can be acquired based on the chart materials, the chart display parameters, and the chart preview parameter, to thus meet the user requirement of viewing an online chart while acquiring in real time the target chart video.

### BRIEF DESCRIPTION OF THE DRAWINGS

In order to make the technical solution according to the embodiments of the present disclosure or the prior art much clearer, a brief introduction of the drawings required in the description pf the embodiments or the prior art will be provided below. Apparently, the drawings described below only relate to some embodiments of the present disclosure, and those skilled in the art could derive other drawings from those drawings, without doing creative work.

FIG. 1 illustrates a flowchart of a chart processing method provided by embodiments of the present disclosure;

FIG. 2 illustrates a schematic diagram of interaction between a server and a client provided by embodiments of the present disclosure;

FIG. 3 illustrates a signaling interaction diagram of a chart processing method provided by embodiments of the present disclosure; and

FIG. 4 illustrates a schematic diagram of a structure of a chart processing apparatus provided by embodiments of the present disclosure.

### DETAILED DESCRIPTION OF EMBODIMENTS

In order to enable those skilled in the art to better understand the solution of the present disclosure, a clear, complete description of the technical solution according to the embodiments of the present disclosure will be provided below in conjunction with the drawings of the embodiments of the present disclosure. Obviously, the embodiments described herein are only a part of the embodiments of the present disclosure, not all of them. All the other embodiments that the ordinary skilled in the art can acquire on the basis of the embodiments described herein, without doing creative work, fall into the protection scope of the present disclosure.

Reference below will be made to the drawings to describe in detail various non-limiting implementations of the present disclosure.

### Example Method

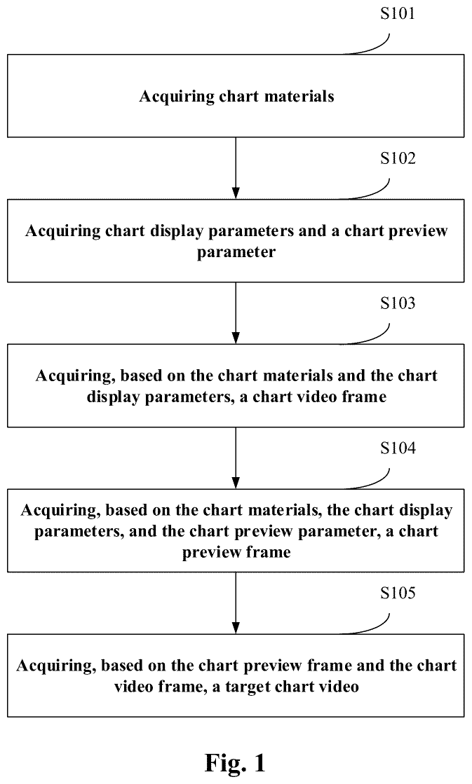

FIG. 1 illustrates a flowchart of a chart processing method provided by embodiments of the present disclosure. In these embodiments, the chart processing method can be applied to a chart processing system that may include a client and a server. In an example, the method may include, for example, the following steps S101 through S105.

S101: acquiring chart materials.

In the embodiments of the present disclosure, the chart materials may be materials used for generating a chart. In an example, the chart materials may include data, a title, a label, and a legend, where: the data are used for generating a chart content; the title is used as a title of the generated chart; the label is a label of the chart data; the legend is an auxiliary content of the chart, which can help a user understand the content of the chart.

In the embodiments of the present disclosure, the client and the serve can acquire the chart materials, respectively. In an example, the client can acquire the chart materials set by the user. For example, the user can set the chart materials on a front-end page. After acquiring the chart materials set by the user, the client can send the chart materials to the server.

S102: acquiring chart display parameters and a chart preview parameter.

In the embodiments of the present disclosure, the chart display parameters may be parameters for determining a chart display mode. In an example, the chart display parameters may include: color, font, font size, and type. Wherein, the color may be a color of the chart, or a color of the font. The font may be a font of text in the chart, and/or a font of the chart title. The font size may be a font size of the text in the chart, and/or a font size of the chart title. The type may indicate a chart type that includes, but is not limited to, a column chart, a line chart, a pie chart, and the like.

In the embodiments of the present disclosure, the client and the server may acquire the chart display parameters, respectively. In an example, the client can acquire the chart display parameters set by the user. For example, the user can set the chart display parameters on a front-end page. After acquiring the chart display parameters set by the user, the client can send the chart display parameters to the server.

In the embodiments of the present disclosure, the chart preview parameter may be a parameter that can achieve a chart preview effect meeting the users' need. In an example, the chart preview parameter may include a preview time.

In the embodiments of the present disclosure, the client can acquire the chart preview parameter. In a specific example, the client can display a chart video preview window on the front-end page. The user can select a preview time in the chart video preview window. In an example, the chart preview parameter includes a preview time. In the case, the client can acquire a selected first time in response to a preview-time selection operation triggered in the chart preview window.

S103: acquiring, based on the chart materials and the chart display parameters, a chart video frame.

In an example, after acquiring the chart materials and the chart display parameters, the server can acquire, based on the chart materials and the chart display parameters, a chart video frame. In an example, the server can render, based on the chart materials and the chart display parameters, the chart video frame. As an example, the server may include a rendering module for rendering, based on the chart materials and the chart display parameters, the chart video frame. In a specific example, the rendering module can process the chart materials and the chart display parameters using a script model to acquire a first chart rendering object, and can further render, based on the first chart rendering object, the chart video frame.

In the embodiments of the present disclosure, the script model is used for describing respective rendering objects of the rendered chart video frame, including a script, a storyboard, an element and the like. The script model may be translated into specific instances and objects when the program is running. Wherein:

The rendering object is a basic component of the rendering core. In an example, the renderable content can be abstracted as an element. For example, the chart, the image, the text or the like can be considered as an element during rendering. Each element is responsible for “preparing” its own content to be rendered, and waiting to be rendered to the render target.

The storyboard can also be read as clips, where each clip includes a plurality of elements, and elements are not reused among clips. Elements in the same clip have exactly the same lifecycle.

The script is used for describing a relationship between clips.

In an example, in addition to the rendering module, the server may include a video synthesis module for generating a target chart video. In an example, the video synthesis module may be a module for interaction between the server and the client. In a specific example, the video synthesis module of the server can receive the chart materials and the chart display parameters sent by the client, and can further send the chart materials and the chart display parameters to the rendering module. Then, the rendering module can render, based on the chart materials and the chart display parameters, the chart video frame.

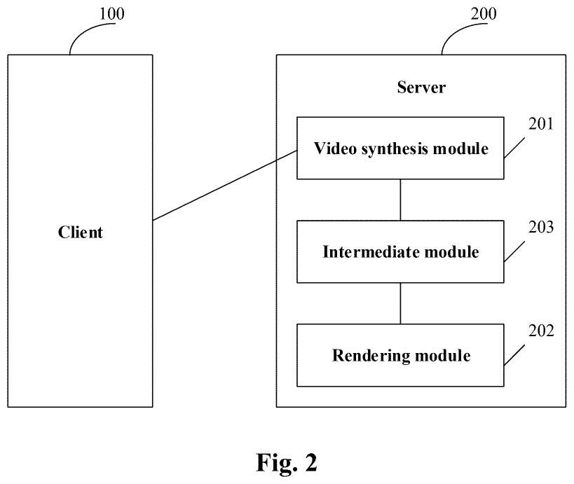

The interaction between the server and the client may be understood in conjunction with FIG. 2. FIG. 2 is a schematic diagram of interaction between the server and the client provided by the embodiments of the present disclosure. As shown in FIG. 2:

The server 200 includes a video synthesis module 201 and a rendering module 202.

The client 100 can send the video materials and the video display parameters to the video synthesis module 201; the video synthesis module 201 sends the video materials and the video display parameters to the rendering module 202. The rendering module 202 renders the chart video frame based on the video materials and the video display parameters, and sends the chart video frame to the video synthesis module 201. The video synthesis module 201 acquires, based on the chart preview frame and the chart video frame, a target chart video.

In an example, the video synthesis module 201 and the rendering module 202 may use different programming languages. For example, the video synthesis module 201 uses a first programming language (e.g. C++ language), and the rendering module 202 uses a second programming language (e.g. JavaScript language). In the circumstance, the video synthesis module 201 and the rendering module 202 can communicate with each other via an intermediate module 203 configured for implementing conversion between the first programming language and the second programming language. The intermediate module 203 may be a module, or may include a plurality of sub-modules, which is not specifically limited in the embodiments of the present disclosure.

S104: acquiring, based on the chart materials, the chart display parameters, and the chart preview parameter, a chart preview frame.

In the embodiments of the present disclosure, after acquiring the chart materials, the chart display parameter and the chart preview parameter, the client can acquire, based on the chart materials, the chart display parameters, and the chart preview parameter, a chart preview frame. If the chart preview parameter is a first time, the client can acquire a chart preview frame corresponding to the first time. In the case, it can be achieved to preview in real time the chart preview frame corresponding to the preview time selected by the user.

In the specific implementation, after acquiring, based on the chart materials, the chart display parameters, and the chart preview parameter, the chart preview frame, the client can render, based on the chart materials, the chart display parameters, and the chart preview parameter, the chart preview frame. The client renders the chart preview frame in a similar way to that the server renders the chart video frame. The client can process the chart materials, the chart display parameters, and the chart preview parameter using the script model to acquire a second chart rendering object, and can render, based on the second chart rendering object, the chart preview frame. For the script model, see the related description in the foregoing for details which are omitted herein for brevity.

In the embodiments of the present disclosure, when the client and the server are performing rendering, the scheme of using Canvas 2D can be employed. Specifically, the client may use a Canvas 2D function of a browser, which is a universal standard function universally supported by all browsers. The server may use a node-canvas library which is a node.js library with the function comparable to the browser Canvas 2D standard function, and can provide nearly the same Application Programming Interface (API) as the browser Canvas 2D does. In the case, since both the client and the server use the Canvas 2D for rendering, the chart video frame rendered by the server and the chart preview frame rendered by the client are substantially the same.

S105: acquiring, based on the chart preview frame and the chart video frame, a target chart video.

In the embodiments of the present disclosure, the server can acquire, based on the chart preview frame and the chart video frame, a target chart video. In an example, the video synthesis module of the server can acquire, based on the chart preview frame and the chart video frame, a target chart video.

In an example, the user can trigger a preset operation on a preview interface of the chart preview frame, and in response to the preset operation, the server can acquire, based on the chart video frame, the target chart video. In an example, the preset operation may be, for example, a video generation operation triggered by a video generation control. In an example, the server can synthesize a plurality of chart video frames acquired by rendering, to acquire the target chart video. In a specific example, the video synthesis module of the server can synthesize a plurality of chart video frames sent by the rendering module, to acquire the target chart video. In an example, the target chart video may be a complete video acquired from the chart materials. In a further example, if the chart preview frame is the chart preview frame corresponding to the first time, the target chart video may be a video synthesized from chart video frames preceding the first time.

In an example, the server can also send the download link of the target chart video to the client, the client can download and store the target chart video, and the target chart video can be viewed on an electronic device having the client running thereon.

From the above description, it could be learned that, with the solution, a chart video frame can be acquired based on the chart materials and the chart display parameters while a chart preview frame can be acquired based on the chart materials, the chart display parameters, and the chart preview parameter, to thus meet the user requirement of viewing an online chart while acquiring in real time the target chart video. Moreover, the server can render the chart video frame in similar rendering logic as the client does, and can generate, based on the chart video frame, a target chart video. Therefore, the target chart video can be played smoothly.

Subsequently, the chart processing method provided by the embodiments of the present disclosure will be introduced from the perspective of signaling interaction.

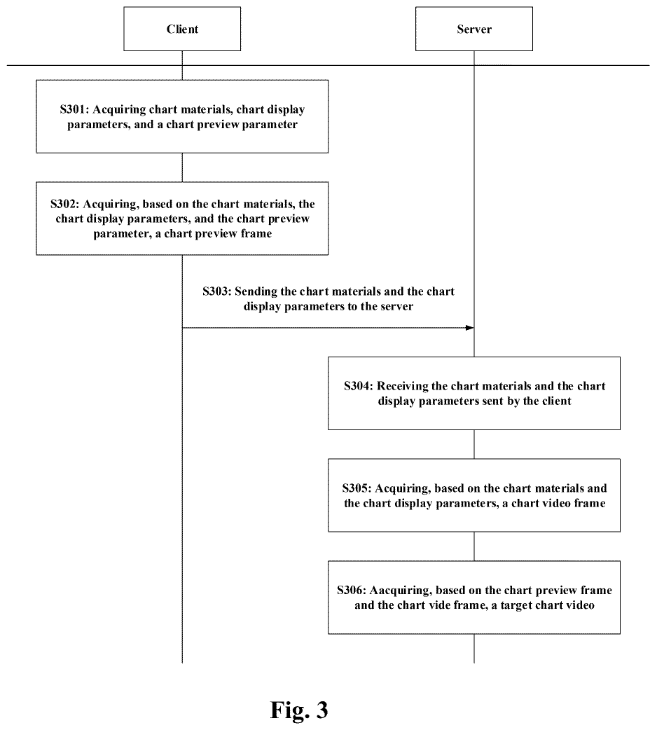

FIG. 3 is a signaling interaction diagram of a chart processing method provided by embodiments of the present disclosure. The method as shown therein may include S301 through S306.

S301: the client acquires chart materials, chart display parameters, and a chart preview parameter.

S302: the client acquires, based on the chart materials, the chart display parameters, and the chart preview parameter, a chart preview frame.

S303: the client sends the chart materials and the chart display parameters to the server.

S304: the server receives the chart materials and the chart display parameters sent by the client.

S305: the server acquires, based on the chart materials and the chart display parameters, a chart video frame.

S306: the server acquires, based on the chart preview frame and the chart video frame, a target chart video.

For the specific implementations of S301 through S306, see the related description in the foregoing for details which are omitted herein for brevity.

### Example Apparatus

On the basis of the method provided by the above embodiments, the embodiments of the present disclosure further provide an apparatus. Reference now will be made to the drawings to describe the apparatus.

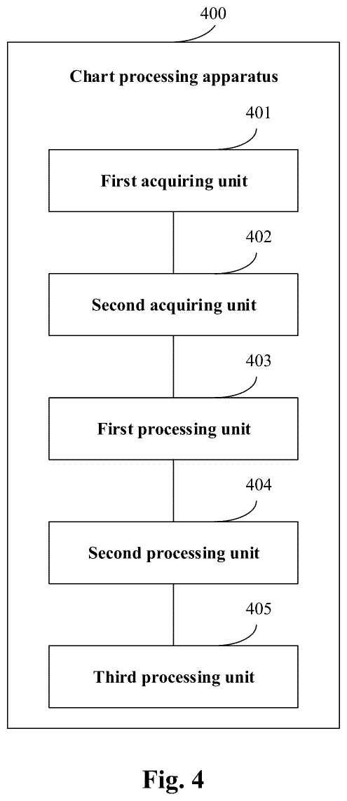

FIG. 4 is a schematic diagram of a structure of a chart processing apparatus provided by the embodiments of the present disclosure. For example, the apparatus 400 may specifically include: a first acquiring unit 401, a second acquiring unit 402, a first processing unit 403, a second processing unit 404 and a third processing unit 405.

The first acquiring unit 401 is used for acquiring chart materials;

The second acquiring unit 402 is used for acquiring chart display parameters and a chart preview parameter.

The first processing unit 403 is used for acquiring, based on the chart materials and the chart display parameters, a chart video frame.

The second processing unit 404 is used for acquiring, based on the chart materials, the chart display parameters, and the chart preview parameter, a chart preview frame.

The third processing unit 405 is used for acquiring, based on the chart preview frame and the chart video frame, a target chart video.

Alternatively,
the chart materials include: data, a title, a label, and a legend; and
the chart display parameters include: color, font, font size, and type.

Alternatively, acquiring the chart preview parameter includes:
in response to a preview-time selection operation triggered in a chart video preview window, acquiring a selected first time; and
the second processing unit 404 is used for:
acquiring, based on the chart materials and the chart display parameters, a chart preview frame corresponding to the first time.

Alternatively, the first processing unit 403 is used for:
processing, by a rendering module, the chart materials and the chart display parameters using a script model to acquire a first chart rendering object; and
rendering, by the rendering module and based on the first chart rendering object, the chart video frame.

Alternatively, the apparatus further includes:
a sending unit for sending, by the rendering module, the chart video frame to a video synthesis module;
the third processing unit is used for:
acquiring, by the video synthesis module and based on the chart preview frame and the chart video frame, the target chart video.

Alternatively, the second processing unit 404 is used for:
processing the chart materials, the chart display parameters, and the chart preview parameter using the script model to acquire a second chart rendering object; and
rendering, based on the second chart preview object, the chart preview frame.

Alternatively, the third processing unit 405 is used for:
in response to a preset operation triggered on a preview interface of the chart preview frame, acquiring, based on the chart video frame, the target chart video.

The apparatus 400 corresponds to the method provided by the method embodiments, and specific implementations of respective units of the apparatus 400 belong to the same idea as the method embodiments do. Therefore, for the specific implementations of the respective units of the apparatus 400, see the description of the method embodiments for details which are omitted herein for brevity.

The embodiments of the present disclosure provide a device comprising a processor and a memory;
where the processor is configured to execute instructions stored in the memory, to cause the device to perform the method of any of the above method embodiments.

The embodiments of the present disclosure further provide a computer readable storage medium including instructions that instruct a device to perform the method of any of the above method embodiments.

The embodiments of the present disclosure further provide a computer program product, where the computer program product, when running on a computer, causes the computer to perform the method of any of the above method embodiments.

It would be appreciated that, prior to applying the technical solution according to various embodiments of the present disclosure, the user should be informed of the type, scope of use, and use scenario of the personal information involved in an appropriate manner, and user authorization should be acquired. For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers, or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

It is to be understood that the above process of notifying and acquiring the user authorization is only illustrative, without constituting any limitation to the implementations of the present disclosure. Other methods compliant with the provisions of the relevant laws and regulations can also be applied to the implementations of the present disclosure.

Considering the Description and the practice of the invention described herein, those skilled in the art would easily envision other implementation solutions of the present disclosure. The present disclosure intends to cover any variations, uses or adaptive changes thereof, which follow the general principle of the present disclosure and include common knowledge or customary technical means in the art not disclosed herein. The Description and the embodiments are provided only exemplarily, and the actual scope and spirits of the present disclosure are indicated by the appended claims.

It would be appreciated that the present disclosure is not confined to the exact structure described above and shown in the drawings, but instead allows various modifications and changes not departing from the scope thereof. The scope of the present disclosure is defined by the appended claims only.

Above described are only optimal embodiments of the present disclosure, without suggesting any limitation to the protection scope of the present disclosure. Within the spirits and principles described herein, any modification, equivalent replacement, improvement, and the like shall fall into the protection scope of the present disclosure.

1. A chart processing method comprising:
acquiring chart materials;
acquiring chart display parameters and a chart preview parameter;
acquiring, based on the chart materials and the chart display parameters, a chart video frame;
acquiring, based on the chart materials, the chart display parameters, and the chart preview parameter, a chart preview frame;
acquiring, based on the chart preview frame and the chart video frame, a target chart video.

2. The method of claim 1, wherein,
the chart materials comprise: data, a title, a label, and a legend; and
the chart display parameters comprise: color, font, font size, and type.

3. The method of claim 1, wherein acquiring the chart preview parameter comprises:
in response to a preview-time selection operation triggered in a chart video preview window, acquiring a selected first time;
wherein acquiring, based on the chart materials, the chart display parameters, and the chart preview parameter, the chart preview frame comprises:
acquiring, based on the chart materials and the chart display parameters, a chart preview frame corresponding to the first time.

4. The method of claim 1, wherein acquiring, based on the chart materials and the chart display parameters, the chart video frame comprises:
processing, by a rendering module, the chart materials and the chart display parameters using a script model to acquire a first chart rendering object;
rendering, by the rendering module and based on the first chart rendering object, the chart video frame.

5. The method of claim 4, further comprising:
sending, by the rendering module, the chart video frame to a video synthesis module;
wherein acquiring, based on the chart preview frame and the chart video frame, the target chart video comprises:
acquiring, by the video synthesis module and based on the chart preview frame and the chart video frame, the target chart video.

6. The method of claim 1, wherein acquiring, based on the chart materials, the chart display parameters, and the chart preview parameter, the chart preview frame comprises:
processing the chart materials, the chart display parameters, and the chart preview parameter using the script model to acquire a second chart rendering object;
rendering, based on the second chart rendering object, the chart preview frame.

7. The method of claim 1, wherein acquiring, based on the chart preview frame and the chart video frame, the target chart video comprises:
in response to a preset operation triggered on a preview interface of the chart preview frame, acquiring, based on the chart video frame, the target chart video.

8. (canceled)

9. A device, characterized in that, the device comprises a processor and a memory;
wherein the processor is configured to execute instructions stored in the memory, to cause the device to perform a chart processing method comprising:
acquiring chart materials;
acquiring chart display parameters and a chart preview parameter;
acquiring, based on the chart materials and the chart display parameters, a chart video frame;
acquiring, based on the chart materials, the chart display parameters, and the chart preview parameter, a chart preview frame;
acquiring, based on the chart preview frame and the chart video frame, a target chart video.

10-11. (canceled)

12. The device of claim 9, wherein,
the chart materials comprise: data, a title, a label, and a legend; and
the chart display parameters comprise: color, font, font size, and type.

13. The device of claim 9, wherein acquiring the chart preview parameter comprises:
in response to a preview-time selection operation triggered in a chart video preview window, acquiring a selected first time;
wherein acquiring, based on the chart materials, the chart display parameters, and the chart preview parameter, the chart preview frame comprises:
acquiring, based on the chart materials and the chart display parameters, a chart preview frame corresponding to the first time.

14. The device of claim 9, wherein acquiring, based on the chart materials and the chart display parameters, the chart video frame comprises:
processing, by a rendering module, the chart materials and the chart display parameters using a script model to acquire a first chart rendering object;
rendering, by the rendering module and based on the first chart rendering object, the chart video frame.

15. The device of claim 14, wherein the chart processing method further comprises:
sending, by the rendering module, the chart video frame to a video synthesis module;
wherein acquiring, based on the chart preview frame and the chart video frame, the target chart video comprises:
acquiring, by the video synthesis module and based on the chart preview frame and the chart video frame, the target chart video.

16. The device of claim 9, wherein acquiring, based on the chart materials, the chart display parameters, and the chart preview parameter, the chart preview frame comprises:
processing the chart materials, the chart display parameters, and the chart preview parameter using the script model to acquire a second chart rendering object;
rendering, based on the second chart rendering object, the chart preview frame.

17. The device of claim 9, wherein acquiring, based on the chart preview frame and the chart video frame, the target chart video comprises:
in response to a preset operation triggered on a preview interface of the chart preview frame, acquiring, based on the chart video frame, the target chart video.

18. A non-transitory computer readable storage medium characterized in comprising instructions that instruct a device to perform a chart processing method comprising:
acquiring chart materials;
acquiring chart display parameters and a chart preview parameter;
acquiring, based on the chart materials and the chart display parameters, a chart video frame;
acquiring, based on the chart materials, the chart display parameters, and the chart preview parameter, a chart preview frame;
acquiring, based on the chart preview frame and the chart video frame, a target chart video.

19. The non-transitory computer readable storage medium of claim 18, wherein,
the chart materials comprise: data, a title, a label, and a legend; and
the chart display parameters comprise: color, font, font size, and type.

20. The non-transitory computer readable storage medium of claim 18, wherein acquiring the chart preview parameter comprises:
in response to a preview-time selection operation triggered in a chart video preview window, acquiring a selected first time;
wherein acquiring, based on the chart materials, the chart display parameters, and the chart preview parameter, the chart preview frame comprises:
acquiring, based on the chart materials and the chart display parameters, a chart preview frame corresponding to the first time.

21. The non-transitory computer readable storage medium of claim 18, wherein acquiring, based on the chart materials and the chart display parameters, the chart video frame comprises:
processing, by a rendering module, the chart materials and the chart display parameters using a script model to acquire a first chart rendering object;
rendering, by the rendering module and based on the first chart rendering object, the chart video frame.

22. The non-transitory computer readable storage medium of claim 21, wherein the chart processing method further comprises:
sending, by the rendering module, the chart video frame to a video synthesis module;
wherein acquiring, based on the chart preview frame and the chart video frame, the target chart video comprises:
acquiring, by the video synthesis module and based on the chart preview frame and the chart video frame, the target chart video.

23. The non-transitory computer readable storage medium of claim 18, wherein acquiring, based on the chart materials, the chart display parameters, and the chart preview parameter, the chart preview frame comprises:
processing the chart materials, the chart display parameters, and the chart preview parameter using the script model to acquire a second chart rendering object;
rendering, based on the second chart rendering object, the chart preview frame.
